(19) United States
(12) Patent Application Publication
(10) Pub. No.: US 2023/0234117 A1
(43) Pub. Date: Jul. 27, 2023

(54) CROWNING METHOD IN PRESS BRAKE AND PRESS BRAKE

(71) Applicant: Amada Co., Ltd., Kanagawa (JP)

(72) Inventors: Taishi SUZUKI, Kanagawa (JP); Koutaku MIURA, Kanagawa (JP); Makoto AOKI, Kanagawa (JP)

(21) Appl. No.: 18/129,595

(22) Filed: Mar. 31, 2023

Related U.S. Application Data
(63) Continuation of application No. 16/970,721, filed on Aug. 18, 2020.

(30) Foreign Application Priority Data
Feb. 22, 2018 (JP) 2018-029752

(51) Int. Cl. B21D 5/02; B21D 5/00

(52) U.S. Cl. CPC B21D 5/02; B21D 5/006; B30B 15/007

(57) ABSTRACT

A crowning method is applied to a bending process by a press brake comprising an upper table and a lower table as being vertically opposed to each other, wherein the lower table comprises slits respectively opened in right and left directions, to bend a workpiece put and deviated rightward or leftward on the lower table so as to extend the workpiece over at least one of upper portions of the slits, the crowning method comprising: deforming end sides of the upper portions of the slits of the lower table so as to warp the one of the upper portions upward to carry out a crowning regulation.

### CROSS-REFERENCE TO RELATED APPLICATIONS

This application is a continuation of application Ser. No. 16/970,721, filed Aug. 18, 2020, which is a 371 of International Application No. PCT/JP2019/005229, filed Feb. 14, 2019, which in turn is based upon and claims the benefit of priority from Japanese Patent Application No. 2018-029752, filed Feb. 22, 2018, the entire disclosures of which are incorporated herein by reference.

### BACKGROUND

### Technical Field

The disclosure herein relates to a crowning method in a press brake and the press brake for itself. In more detail, the disclosure herein relates to a method for actively drawing downward both right and left end sides of a lower table in a press brake, or pressing upward both the end sides, to carry out a crowning of the lower table, and the press brake used in the method.

### Description of the Related Art

Bending a workpiece into a V-letter shape would be carried out by supplying a plate-like workpiece in between upper and lower dies provided on upper and lower tables in a press brake and bending the workpiece. Right and left end sides of the upper and lower tables in the press brake are meanwhile so constituted as to be supported by right and left side frames. More specifically, the upper and lower tables are so constituted as to be supported at both ends.

Therefore, when the workpiece is bent by the upper and lower dies into a V-letter shape, central portions and these vicinities of the upper and lower tables tend to curve to come apart from each other. Bending angles around the central portions thus tend to be looser (larger) than those of both the right and left end sides of the workpiece after being bent into the V-letter shape. More specifically, the workpiece after being bent tends to be in a boat form.

Consequently, to improve through-out accuracy, it is usual to carry out a crowning so as to make them curve so as to keep parallelism between when carrying out a bending the workpiece. As a method for crowning as described above, frequently executed is to curve in advance the upper dies provided on the upper table downward in a projecting manner, or to curve the lower table upward in a projecting manner. And, as a constitution for curving the lower table upward, it is proposed that the lower table is, at both right and left end sides, provided with slits opened (exposed) to the right and left directions so as to render the right and left end sides of the lower table be easy to curve downward. The PTLs 1 and 2 disclose related arts.

### CITATION LIST

### Patent Literature

PTL 1: Japanese Patent No. 5514276

PTL 2: Japanese Patent Application Laid-open No. 2001-121214

### SUMMARY

In the constitutions recited in the PTLs 1 and 2, the lower table curves to follow the curvature of the upper table and then the workpiece is bent. The through-out accuracy is therefore improved. The PTLs 1 and 2 are, however, arts used on the assumption that both the end sides of the workpiece elongated in the right and left directions are positioned above the right and left slits in a case where the workpiece is set in place at the central portion in the right and left directions of the upper and lower worktables and in this condition the workpiece is bent.

It is therefore uneasy to ensure accuracy of bending in a case, for example, where the workpiece has a length sufficient to dispose both right and left sides of the workpiece slightly above the slits, or in a case where it is shorter than the interval between the right and left slits.

Further, in a case where, dies are respectively mounted on a plurality of sites on the upper and lower tables so as to carry out a step-bending for example, the dies are mounted on the left side, the central portion and the right side of the upper and lower tables for example. Therefore, the die mounted at the side and the die mounted at the right side for example, because of difference in warping (curving) deformation in the upper and lower tables, create different bending accuracy to the workpiece.

The disclosure heretofore has been created in light of the aforementioned problems and is intended to carry out a crowning of the left side or the right side or the whole of the lower table to execute bending with sufficient through-out accuracy.

According to a first aspect, a crowning method is applied to a bending process by a press brake comprising an upper table and a lower table as being vertically opposed to each other, wherein the lower table comprises slits respectively opened in right and left directions, to bend a workpiece put and deviated rightward or leftward on the lower table so as to extend the workpiece over at least one of upper portions of the slits, the crowning method comprising: deforming end sides of the upper portions of the slits of the lower table so as to warp the one of the upper portions upward to carry out a crowning regulation.

### ADVANTAGEOUS EFFECTS OF INVENTION

According to the present invention, a crowning of the left side and a crowning of the right side of the upper table or the lower table can be independently carried out. In addition, a crowning of both the right and left sides can be simultaneously carried out. A proper crowning can be therefore carried out corresponding to cases where a workpiece is bent at the left side or the right side or the central portion of the upper table or the lower table. The through-out accuracy can be thus improved in a case where bending is carried out at the left side or the right side or the central portion of the lower table for example.

Further, a crowning can be carried out on the whole length of the lower table. Therefore, even if the workpiece is very long in the right and left directions, accurate bending can be carried out.

### BRIEF DESCRIPTION OF THE DRAWINGS

FIG. 1 is an elevational view schematically showing a press brake according to a first embodiment.

FIG. 2 is a side view of the press brake in FIG. 1 viewed from the left side.

FIG. 3 is a partial sectional side view taken from the line III-III in FIG. 1, mainly showing deformation means.

FIG. 4 is an elevational view schematically showing a press brake according to a second embodiment.

FIG. 5 is an elevational view schematically showing a press brake according to a third embodiment.

FIG. 6 is an elevational view schematically showing a press brake according to a fourth embodiment.

FIG. 7 is an elevational view schematically showing a press brake according to a fifth embodiment.

FIG. 8 is an elevational view schematically showing a press brake according to a sixth embodiment.

FIG. 9 is an elevational view schematically showing a press brake according to a seventh embodiment, where the upper table is omitted and thus only the lower table is mainly shown.

FIG. 10 is a partial sectional plan view mainly showing a lower table, a front plate and a rear plate.

### DESCRIPTION OF EMBODIMENTS

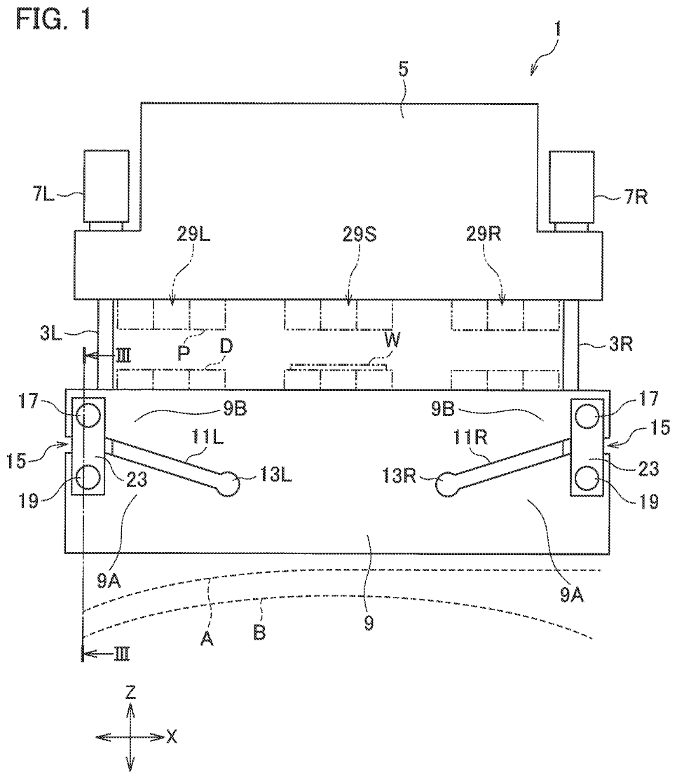

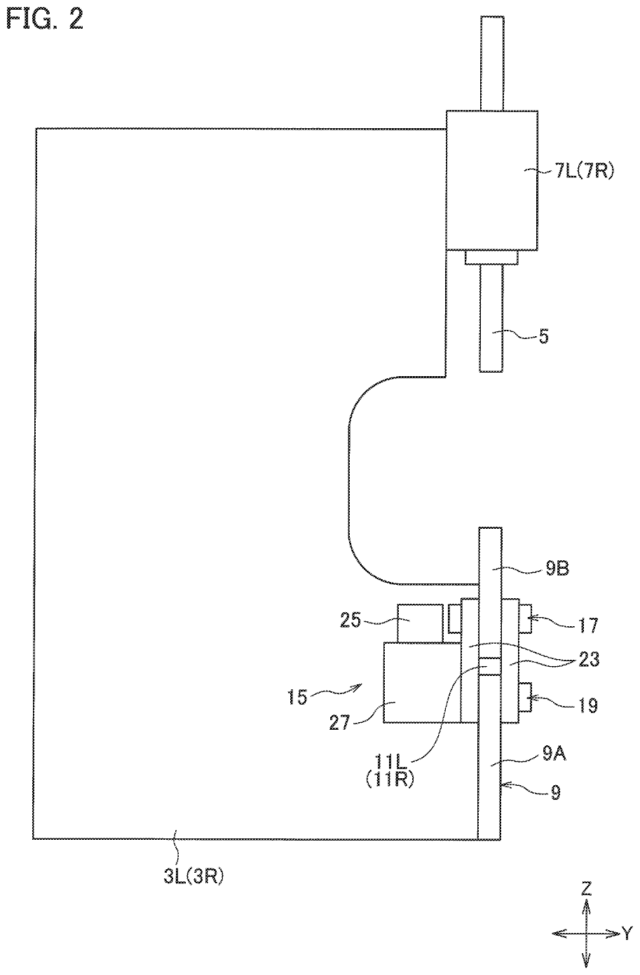

Certain embodiments will be described hereinafter with reference to FIGS. 1 through 10.

Referring to FIG. 1, a press brake 1 according to the first embodiment is provided with left and right side frames 3L, 3R. On upper sides of the side frames 3L, 3R supported is an upper table 5 in a way to be movable upward and downward. Further, to move the upper table 5 upward and downward, on the upper portions of the side frames 3L, 3R, up-and-down operation devices 7L, 7R such as hydraulic cylinders are attached. Further, below the lower portions of the side frames 3L, 3R, a lower table 9 as being vertically opposed to the upper table 5 is provided.

On both right and left sides of the lower table 9, slits 11L, 11R (first slits) opened (giving access) in right and left directions are provided. The slits 11L, 11R are so formed obliquely as to have both the ends in the right and left directions (X-axis directions) elevated. And, proximal end sides (lower end sides in FIG. 1) in the slits 11L, 11R are connected to stress concentration prevention holes 13L, 13R formed in the lower table 9.

In the lower table 9, lower side portions 9A of the slits 11L, 11R constitute fixed portions unitarily fixed to the side frames 3L, 3R. And, upper portions 9B of the slits 11L, 11R are portions capable of warping (deformable) in the upward and downward directions. Therefore, by warping the end sides of the upper portions 9B upward or downward, a crowning of the lower table 9 can be regulated. The upper portions 9B are thus portions that constitute a crowning regulation portion.

To warp the upper portions 9B upward or downward relative to the lower portions 9A, deformation means 15 are provided between the lower portions 9A and the upper portions 9B. The deformation means 15 have a function for warping (curving) the upper portions 9B upward or downward relative to the lower portion 9A. This function is realized by a hydropneumatic mechanism such as a fluid pressure cylinder combined with either or both of the lower portion 9A and the upper portion 9B to widen or narrowing a gap therebetween for example, or a ball screw mechanism, or any various mechanisms.

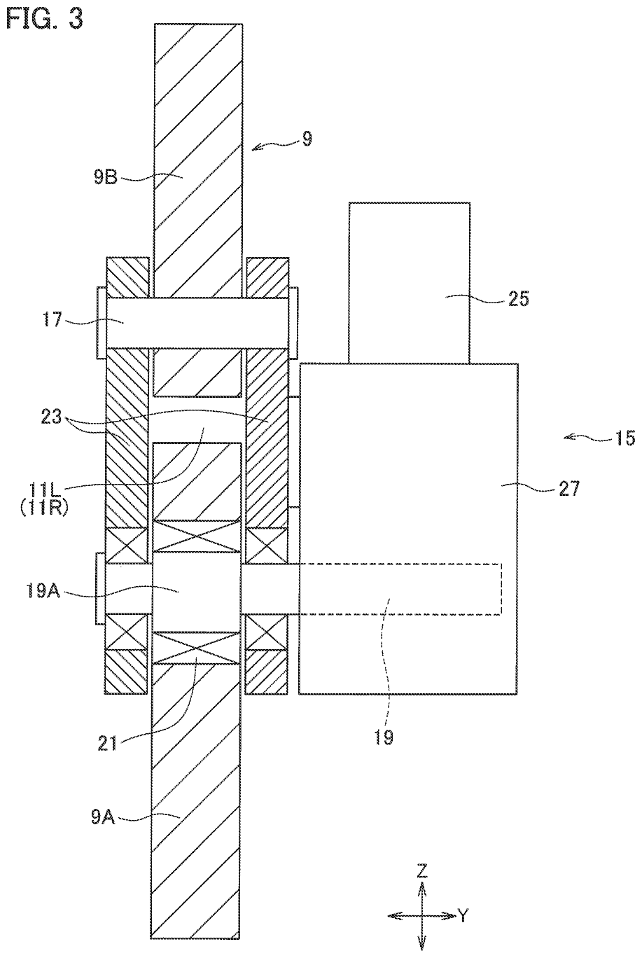

In the present embodiment, an eccentric shaft mechanism as described below is applied to the deformation means 15. More specifically, in the upper portions 9B of the lower table 9, hinge pins 17 (see FIG. 3) penetrate in the front and back directions. And, in the lower portions 9A, eccentric portions 19A of eccentric shafts 19 in the front and back directions rotatably fit with bearings 21 interposed therebetween. And, each eccentric shaft 19 and each hinge pin 17 are connected together by means of a pair of elevation links 23, both end portions of which respectively fit therein.

And, on one of the links 23, a speed reducer driven by a driving motor 25 such as a servomotor is attached. This speed reducer 27 and the eccentric shaft 19 are properly interlocked and connected together. Meanwhile, the speed reducer 27 may be a proper reduction gear mechanism such as a worm reduction gear mechanism. Consequently, descriptions about details of the speed reducer 27 will be omitted. Meanwhile, the driving motor 25 may be provided in a unitary constitution with the speed reducer 27. Thus descriptions about details of attachment constitution of the driving motor 25 will be omitted.

Based on the aforementioned constitution, when the eccentric shaft 19 is rotated by the driving motor 25, as the eccentric portion 19A is rotatably supported by the lower portion 9A, the eccentric shaft 19 comes to move relatively upward and downward. Therefore the elevation link 23 comes to move upward and downward and, via the hinge pin 17, the end side of the upper portion 9B becomes made to move upward and downward. Then the end sides of the upper portions 9B of the lower table 9 are warped (deformed) upward or downward relative to the lower portions 9a. More specifically, a crowning of the lower table 9 can be carried out.

By the way, in the above descriptions, a case where the eccentric shafts 19 are provided on the lower portions 9A was explained. Whether the eccentric shafts 19 are provided on the lower portions 9A or the upper portions 9B is, however, relative. Therefore the eccentric shafts 19 may be provided on either side of the lower portions 9A or the upper portions 9B.

As will be understood from the above descriptions, according to the present embodiment, on both the right and left sides of the lower table 9, the slits 11L, 11R in the right and left directions are formed. And, to actively move upward and downward the end sides of the upper portions 9B relative to both the right and left lower portions 9A, the right and left deformation means 15 are provided. Therefore the right and left upper portions 9B can be independently or simultaneously deformed upward and downward.

Thus, as being corresponding to a case where arrangement positions 29 of upper and lower dies P, D relative to the press brake 1 are located, as shown in FIG. 1 for example, at left and right side positions 29L, 29R and a central position 29S, and deformation of the lower table 9 at a time of carrying out bendings of the workpiece W respectively at the arrangement positions 29S, 29L and 29R, respective crowning regulations can be carried out. More specifically, in a case where the dies P, D are arranged at plural sites in the right and left directions relative to the upper and lower tables 5, 9 and, for example, step-bendings of the workpiece W are to be executed, a proper crowning can be carried out corresponding to respective step-bendings.

In addition, in a case where the workpiece W is properly deviated rightward or leftward relative to the upper and lower tables 5, 9 and is then subject to bending, a crowning of the lower table 9 corresponding to the deviation of the workpiece W can be properly carried out.

More specifically, according to the present embodiment, freedom of crowning regulations of both the right and left sides of the lower table 9 in the press brake 1 is great and therefore the crowning of the lower table 5 can be properly regulated corresponding to the shape and the dimensions of the workpiece W and the position in the right and left directions about bending relative to the upper and lower tables 5, 9.

Therefore, for example, as shown by a curved broken line A in FIG. 1, a crowning can be carried out in a shape in which one side in the right and left directions of the lower table 9 curves to fall downward. More specifically, in a case where the workpiece W is deviated rightward or leftward relative to the upper and lower tables 5, 9 and then bending is carried out, a crowning can be carried out corresponding to the deviation of the workpiece W.

Further, in a case of a workpiece with a long bending line such that both right and left end sides of the workpiece W are positioned above the right and left slits 11L, 11R, a crowning can be carried out in which a central portion in the right and left directions of the lower table 9 is curved to project as shown in the curve B. In this case, the curvature of the lower table 9 can be regulated corresponding to the length in the right and left directions of the workpiece W.

Furthermore, by curving the end sides of the upper portions 9B upward, a crowning can be carried out in which the central portion of the lower table 9 is curved to get dented. In this case, the right and left deformation means 15 can be simultaneously or independently driven and then a desired crowning regulation can be carried out corresponding to a position in the right and left directions of the workpiece and the length of the bending line on the workpiece. Therefore, as being corresponding to a workpiece W with various shapes and various dimensions, accuracy in a bending of the workpiece W can be improved.

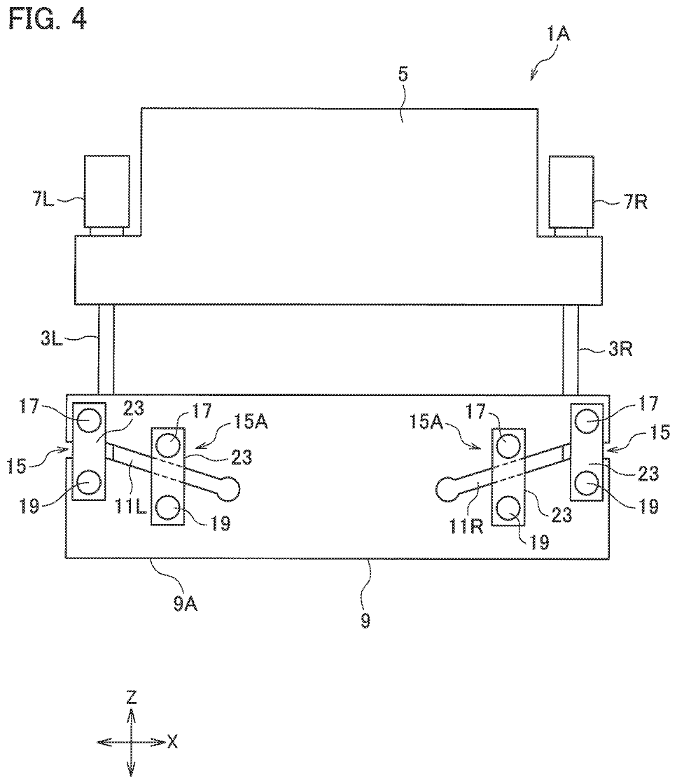

FIG. 4 shows a press brake 1A according to a second embodiment. The same reference signs are attached to elements creating functions identical to those in the first embodiment and detailed descriptions thereabout will be omitted.

In this second embodiment, it has a constitution in that second deformation means 15A having constitutions similar to those of the deformation means 15 are provided in midway positions in the right and left directions of the slits 11L, 11R. More specifically, it has a constitution in that, corresponding to the left and right slits 11L, 11R, a plurality of deformation means 15, 15A are respectively provided.

According to the aforementioned constitution, parts of the hinge pins 17 in the deformation means 15A may be made to be curvature change positions for example, and then multiple steps of crownings can be carried out to differentiate the curvatures around both the end sides of the lower table 9 from the curvature around a central portion thereof. Therefore, a crowning of the lower table 9 can be carried out with greater fineness. A bending can be, therefore, carried out with higher accuracy. In addition, it can address a case where a notch or such exists around a central portion of the workpiece W or such cases, and enables a bending with higher accuracy.

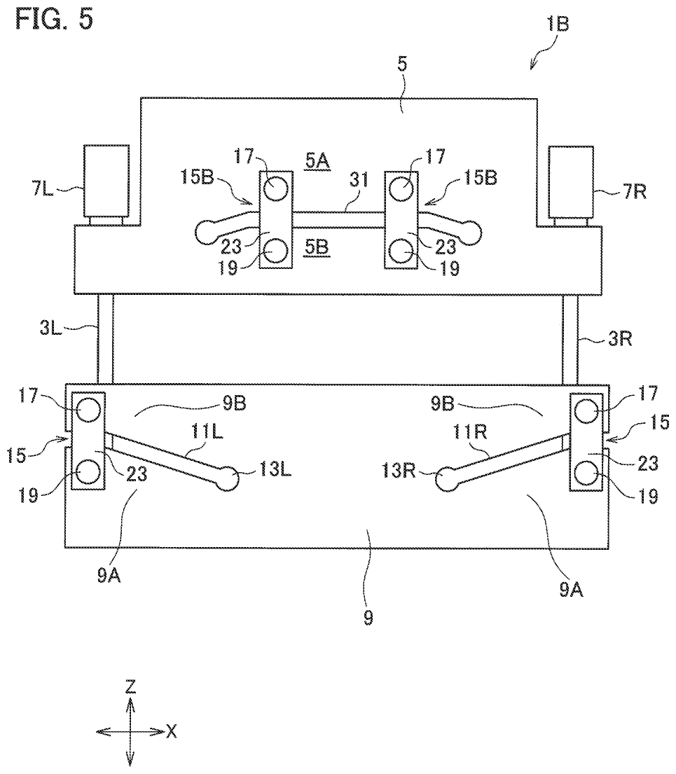

FIG. 5 shows a press brake 1B according to a third embodiment. In this embodiment, it has a constitution in that a slit 31 (second slit) in the right and left directions is formed around a central portion of the upper table 5 and, in between an upper portion 5A and a lower portion 5B of the slit 31, a plurality of third deformation means 15B (crowning regulation means) having constitutions similar to those of the deformation means 15 are provided. The third deformation means 15B are combined with one or both of the upper portion 5A and the lower portion 5B and widen or narrow a gap therebetween to carry out a crowning regulation.

According to the aforementioned constitution, by respectively regulating the plurality of deformation means 15B, a crowning regulation can be carried out in which the central portion of the lower side of the upper table 5 curves to project downward. In this case, by regulating the plurality of deformation means 15B independently, both right and left sides of the upper table 5 can be crowned asymmetrically with respect to the central portion of the upper table 5 as well.

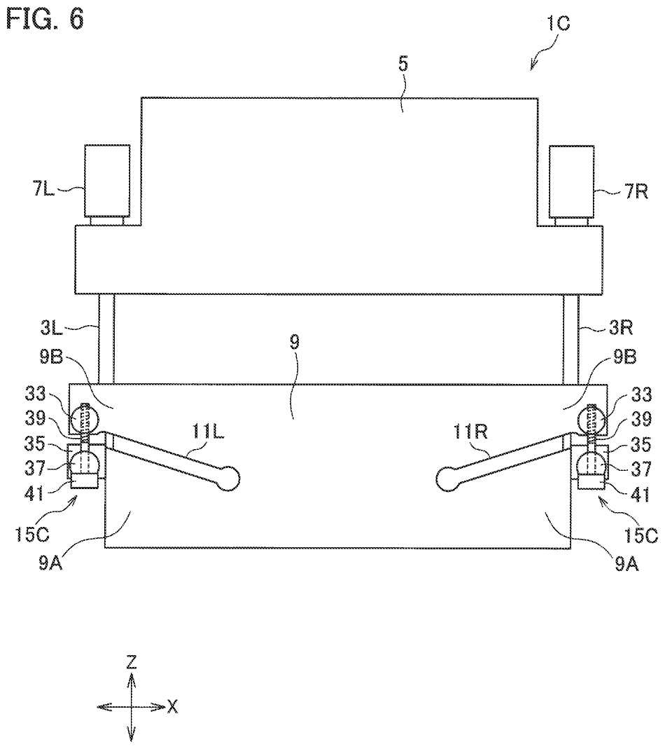

FIG. 6 shows a press brake 1C according to a fourth embodiment. In this embodiment, as a constitution of deformation means 15C, nut members 33 are provided to be rotatable about axial centers that are horizontal in front and back directions (Y-axis direction) at nut retaining hollow portions in the upper portion 9B of the lower table 9. And, within bearing hollow portions of brackets 35 provided on the lower portions 9A, bearing members 37 are supported to be rotatable about axial centers horizontal in front and back directions.

On the bearing members 37, tension bolts 39 penetrating in upward and downward directions are supported, which are only allowed to rotate. And, screw portions at upper sides of the tension bolts 39 are screwed in the nut members 33. The tension bolts 39 are interlocked and connected with proper actuators 41, as rotating means, such as servomotors for example. Meanwhile, as the rotating means, they can be constituted to be manually rotated by any proper handle.

Therefore, by using the actuators 41 to rotate the tension bolts 39, the ends of the upper portions 9B of the lower table 9 can be warped downward. The right and left upper portions 9B can be thus simultaneously or independently warped and then a crowning can be carried out. In this case, a crowning can be carried out in a right-left symmetrical form or in an asymmetrical form.

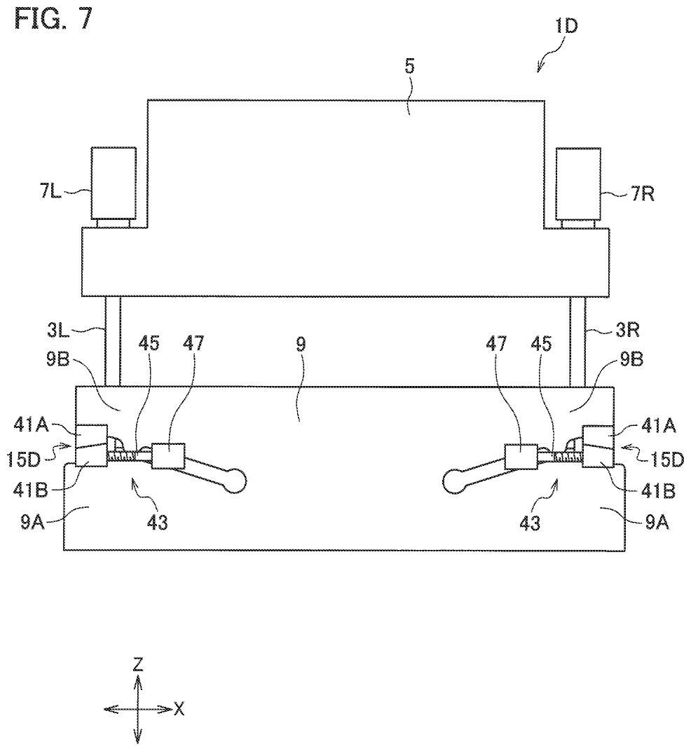

FIG. 7 shows a press brake 1D according to a fifth embodiment. In this embodiment, the deformation means 15D are provided with fixed wedge members 41A on ones of the upper portions 9B and the lower portions 9A of the lower table 9. And, on the others of the upper portions 9B and the lower portions 9A, movable wedge members 41B are provided to be movable in the right and left directions (X-axis direction).

For the purpose of moving the wedge members 41B in the right and left directions in FIG. 7, it is provided with transfer means 43. The transfer means 43 are, as being conceptually and schematically shown therein, provided with screw members 45 that are screwed in the wedge members 41B and motors 47 as rotation means for rotating the screw members 45.

Consequently, as the screw members 45 are rotated by the motors 47, the wedge members 41B move rightward or leftward in FIG. 7. And, as the wedge member 41B moves to the outside in the left direction, the slanted face of the wedge member 41B on the moving side forms a face joint with the slanted face of the wedge member 41A on the stationary side and then the wedge member 41A is pressed and moved upward in FIG. 7. Therefore, the right and left end sides of the upper portions 9B of the lower table 9 is deformed (curved) upward.

More specifically, in the constitution shown in FIG. 7, both the right and left sides in the lower table 9 can be deformed to curve upward. A crowning can be readily carried out as being corresponding to curves of both the right and left sides in the upper table 5.

In addition, by moving the wedge member 41B inside in the right and left directions to form a proper gap between the wedge member 41A and the wedge member 41B, it is allowed to warp the upper portions 9B at the right and the left in the lower table 9 downward. And, as the wedge member 41A abuts on the wedge member 41B, downward warps of the upper portions 9B can be suppressed. More specifically, it can be regulated into a proper crowning.

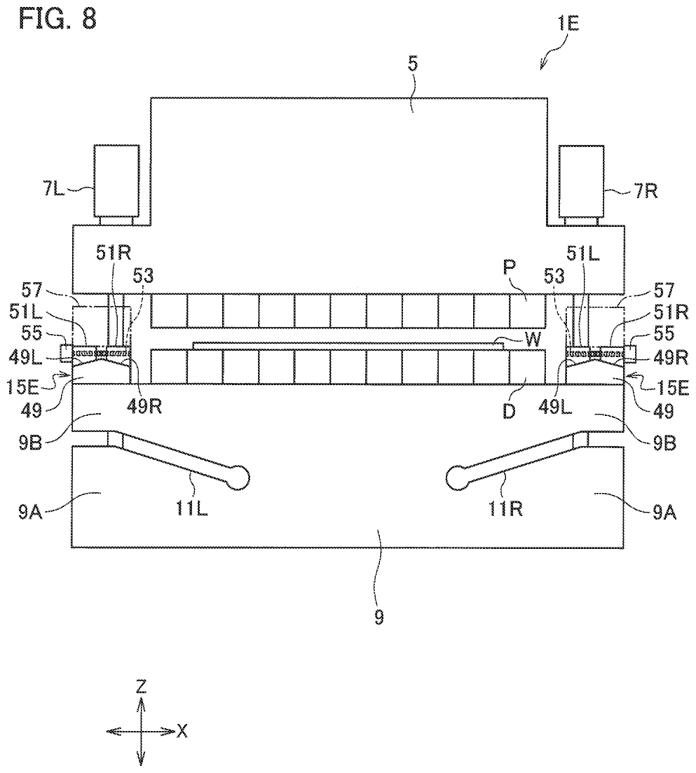

FIG. 8 shows a press brake 1E according to a sixth embodiment. In this embodiment, deformation means 15E are provided on the upper portions 9B of the lower table 9. The deformation means 15E are constituted in the following manner. More specifically, slanted blocks 49 are provided on the upper portions 9B of the lower table 9. On these slanted blocks 49, left and right slanted faces 49L, 49R are formed to be slanted so as to lower both left and right sides thereof.

And, on the slanted faces 49L, 49R, left and right wedge blocks 51L, 51R capable of making positional adjustments in the right and left directions are placed. To make positional adjustments in the right and left directions in a way to move closer or apart the left and right wedge blocks 51L, 51R from each other in synchronization, into the left and right wedge blocks 51L, 51R, screw rods respectively having right and left screws are screwed. These screw rods 53 are interlocked and connected with motors 55 as rotating means.

In the aforementioned constitution, to carry out a bending of the workpiece W by means of the punches P and dies D provided on the upper and lower tables 5 and 9, as the upper table 5 moves downward by means of the up-and-down operation devices 7L, 7R, a bending of the workpiece W starts by means of the punches P and dies D. As described above, when starting the bending, supplemental blocks 57 relatively movably provided on the wedge blocks 51L, 51R are pressed simultaneously.

Therefore, the upper portions 9B of the lower table 9 are pressed downward via the deformation means 15E and then curved. More specifically, the lower table 9 is pressed by the upper table 5 and is then crowned. In this occasion, by moving the wedge blocks 51L, 51R closer or apart from each other by rotation of the screw rods 53 by the motors 55, the timing of the lower table 9 being pressed by the upper table 5 and the shape of the crowning can be regulated.

In other words, by regulating the deformation means 15E, the degree of warping of the upper portions 9B of the lower table 9 can be regulated. More specifically, corresponding to properties, a thickness and a length of bending line of the workpiece W, a proper crowning can be carried out.

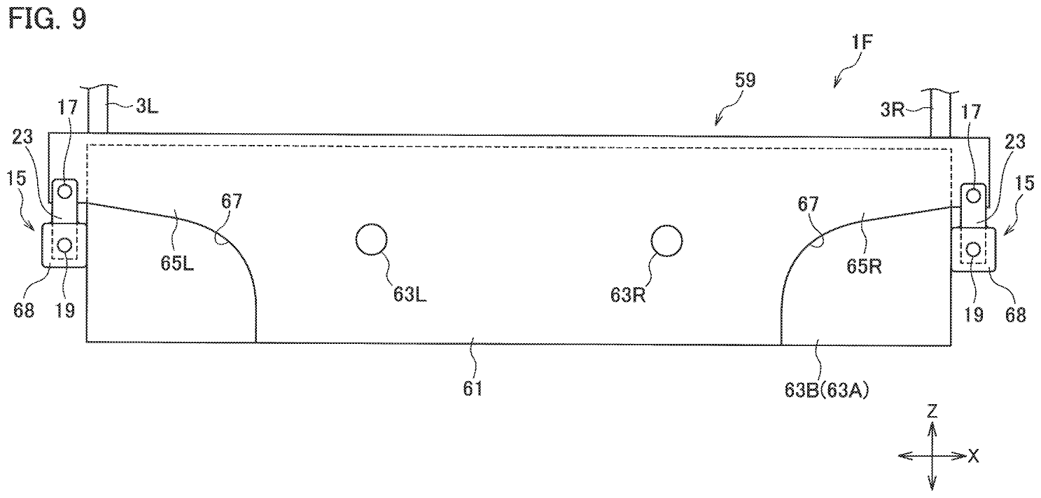

FIG. 9 shows a press brake 1F according to a seventh embodiment, in which the upper table is omitted and only a principal part of the lower table is illustrated. The lower table 59 in the press brake 1F according to this seventh embodiment is constituted in the following way.

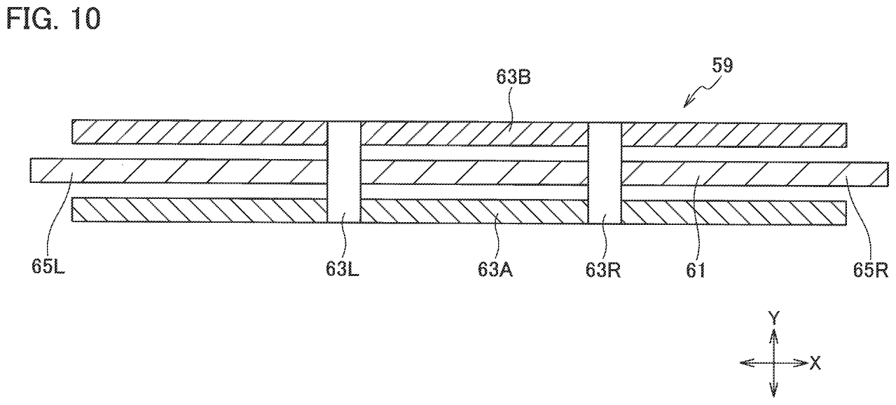

More specifically, the lower table 59 is, as shown in FIG. 10, provided with a table main body 61, a front plate 63A and a back plate 63B disposed in front and back of the table main body 61. Meanwhile, in FIG. 9, the front plate 63A is omitted. Both right and left sides of the front plate 63A and the back plate 63B are unitarily fixed with the side frames 3L, 3R.

The front plate 63A, the back plate 63B and the table main body 61 are unitarily supported by a plurality of pivots 63L, 63R passing through them in the front and rear directions (the vertical direction to the paper surface in FIG. 9 and the upper and lower directions in FIG. 10). On both the right and left sides of the table main body 61, arm portions 65L, 65R elongated in the right and left directions are provided. The upper arm portions 65L, 65R are, as shown in FIG. 9, formed in a shape in that right and left distal end sides thereof gradually taper. In other words, the arm portions 65L, 65R are constituted by forming notch portions 67 on both right and left sides of the table main body 61.

And, to carry out a crowning of the lower table 59 by drawing downward respective distal ends of the arm portions 65L, 65R, which project leftward and rightward from the front plate 63A and the back plate 63B, in between the distal ends of the arm portions 65L, 65R and proximal ends of the side frames 3L, 3R, deformation means 15 (traction means) are provided. In more detail, The deformation means 15 are provided in between brackets 68 provided at the proximal ends of the side frames 3L, 3R and the distal ends of the arm portions 65L, 65R.

By the aforementioned constitution, when the distal ends of the arm portions 65L, 65R are drawn downward by the right and left deformation means 15, the table main body 61 is curved so that the central portion in the right and left directions projects upward and then a crowning is carried out. In this occasion, by regulating the degree of downward drawing, the degree of crowning can be properly regulated.

Meanwhile, it is possible by the deformation means 15 to press the distal ends of the arm portions 65L, 65R upward. Further, by carrying out a traction or an upward press of the arm portions 65L, 65R individually by the right and left deformation means 15, an asymmetric crowning of the lower table 59 is possible.

As will be understood from the above descriptions, according to the present embodiment, by drawing downward, or pressing upward, both the right and left sides of the lower table, a crowning of the lower table can be carried out. Further, by drawing downward one of the right and left sides of the lower table, and pressing upward another thereof, a crowning can be still carried out.

Therefore, in a case where, by arranging (mounting) dies respectively on a plurality of sites on the upper and lower tables in the press brake, a step-bending is to be executed for example, a proper crowning can be carried out corresponding to the mounting sites for the respective dies. Therefore, in a case where a step-bending is to be executed, it is enabled to improve accuracy of bending at the respective die mount sites.

Further, even in a case where a workpiece has a long bending line, a crowning regulation can be carried out so as to project the central portion in the right and left directions of the lower table, and a bending with improved through-out accuracy can be carried out. Still further, a crowning regulation can be carried out so as to render both the right and left sides of the lower table symmetric or asymmetric, and it can be readily adapted to, for example, a workpiece with a proper notch portion at a central portion in the right and left directions.

By the way, in the above descriptions, a case in which the slits 11L, 11R opened in the right and left directions are formed in the lower table 9 was explained. However, it is possible to form slits 11L, 11R in the upper table 5. In this case, an upper portion relative to the slits 11L, 11R in the upper table 5 is corresponding to the fixed portion. And, lower portions relative to the slits 11L, 11R are corresponding to the crowning regulation portion.

Meanwhile, the slits 11L, 11R opened in the right and left directions can be formed in not only one, but also both, of the upper and lower tables 5, 9. In this case, the slits 11L, 11R in the upper and lower tables 5, 9 may be either up-down symmetric or asymmetric. Further, lengths of the slits 11L, 11R in the upper and lower tables 5, 9 in the right and left directions may be different.

Further, as a constitution in which the upper and lower tables 5, 9 have slits, it is possible to render it to be a constitution in which slits 11L, 11R with opened right and left ends and a slit with closed right and left ends, like the slit 31, are properly arranged in a way such as a stepwise arrangement.

Although certain exemplary embodiments are described above, modifications and variations of the embodiments will occur to those skilled in the art, in light of the above teachings.

### INDUSTRIAL APPLICABILITY

In a process of bending by a press brake, a crowning method for improving thereof and a press brake capable of using the same method are provided.

What is claimed is:

1. A crowning method for a bending process by a press brake comprising an upper table and a lower table as being vertically opposed to each other, wherein the lower table comprises slits respectively opened in right and left directions, to bend a workpiece put and deviated rightward or leftward on the lower table so as to extend the workpiece over at least one of upper portions of the slits, the crowning method comprising:
deforming end sides of the upper portions of the slits of the lower table so as to warp the one of the upper portions upward to carry out a crowning regulation.

2. The crowning method as recited in claim 1, wherein the upper table comprises deformation means between the upper portions and lower portions of the slits, the crowning method further comprising:
causing a deformation in the upper portions upward or downward by means of the deformation means.

3. The crowning method as recited in claim 1, wherein the upper table comprises a second slit in right and left directions, the crowning method further comprising:
pressing a lower portion of the second slit downward relative to an upper portion to carry out a crowning regulation of the upper table.

4. A press brake to be used in the crowning method as recited in claim 1, comprising:
an upper table and a lower table vertically opposed to each other;
slits respectively opened in right and left directions on both right and left sides of the lower table; and
right and left deformation means respectively provided between crowning regulation sections of upper portions of the slits and fixed sections of the lower portions, the deformation means for respectively deforming end sides of the crowning regulation sections upward relative to the fixed sections.

5. The press brake as recited in claim 4, wherein the upper table comprises a second slit in the right and left directions, the press brake further comprising:
crowning regulation means for pressing a lower portion of the second slit downward relative to an upper portion thereof to carry out a crowning regulation.
